(19) United States
(12) Patent Application Publication
(10) Pub. No.: US 2012/0272103 A1
(43) Pub. Date: Oct. 25, 2012

(54) SOFTWARE OPERABILITY SERVICE

(75) Inventors: Silviu C. Calinoiu, Redmond, WA (US); Chris Ernest Matichuk, Issaquah, WA (US); Cristian G. Petruta, Redmond, WA (US)

(73) Assignee: MICROSOFT CORPORATION, Redmond, WA (US)

(21) Appl. No.: 13/091,494

(22) Filed: Apr. 21, 2011

(51) Int. Cl. G06F 11/30

(52) U.S. Cl. 714/47.1; 714/E11.179

(57) ABSTRACT

In embodiments of a software operability service, activities of software can be monitored to collect software activity data. A software operability signature for the software can then be generated from the software activity data, and the software operability signature indicates an operability of the software. The software operability signature and associated contextual data can then be communicated to a network service that analyzes the software operability signature. In an embodiment, the network service compares the software operability signature to a baseline operability signature to determine whether the software is operating consistent or inconsistent with the baseline operability signature.

### BACKGROUND

Software applications are susceptible to operation failures or operation regressions caused by operating system updates and/or service pack updates. For example, operating system and/or service pack updates may introduce changes to a computing system that break the compatibility between a hardware device and a corresponding device driver which may lead to a decrease in the performance of the device.

### SUMMARY

This Summary is provided to introduce simplified concepts of a software operability service, and the concepts are further described below in the Detailed Description and/or shown in the Figures. This Summary should not be considered to describe essential features of the claimed subject matter, nor used to determine or limit the scope of the claimed subject matter.

A software operability service is described. In embodiments, activities of software can be monitored to collect software activity data. A software operability signature for the software can then be generated from the software activity data, and the software operability signature indicates an operability of the software. The software operability signature and associated contextual data can then be communicated to a network service that analyzes the software operability signature.

In other embodiments, the network service can receive a software operability signature and associated contextual data from a computing device. The software operability signature indicates an operability of software operating on the computing device. Additional software operability signatures received from additional computing devices can be grouped together. Each of the additional software operability signatures indicates an operability of the software operating on the additional computing devices and is associated with contextual data that is the same or similar to the contextual data associated with the software. A baseline operability signature can then be generated from the additional software operability signatures, and the baseline operability signature indicates normal software operation. The software operability signature can then be compared to the baseline operability signature of the software to determine whether the software is operating consistent with the baseline operability signature or inconsistent with the baseline operability signature. In embodiments, the baseline operability signature that indicates normal software operation may be a function of the context in which the software operability signatures are generated.

In other embodiments, it may be determined that software is operating inconsistent with the baseline operability signature based on the software operability signature. The network service can then determine that operating inconsistent with the baseline operability signature corresponds to normal software operation. Accordingly, a new baseline operability signature of the software can then be generated based on the software operability signature. Alternatively, the network service can analyze the software operability signature to determine an operation failure or operation regression of the software when it is determined that the software is operating inconsistent with the baseline operability signature based on the software signature. The network service can also determine a cause of the operation failure or regression, and initiate a solution to mitigate the operation failure or regression of the software.

### BRIEF DESCRIPTION OF THE DRAWINGS

Embodiments of a software operability service are described with reference to the following Figures. The same numbers may be used throughout to reference like features and components that are shown in the Figures:

FIG. 1 illustrates an example system in which embodiments of a software operability service can be implemented.

FIG. 2 illustrates a network service that implements a software operability service in accordance with one or more embodiments.

FIG. 3 illustrates example method(s) of a software operability service in accordance with one or more embodiments.

FIG. 4 illustrates additional example method(s) of a software operability service in accordance with one or more embodiments.

FIG. 5 illustrates additional example method(s) of a software operability service in accordance with one or more embodiments.

FIG. 6 illustrates various components of an example device that can implement embodiments of a software operability service.

### DETAILED DESCRIPTION

A software operability service is described. In embodiments, a software operability module can be implemented to monitor activities of software to collect software activity data, such as from any type of software, application, device driver, firmware (e.g., device firmware or system firmware), microcode, hardware components, or any combination thereof. The software operability module can then generate a software operability signature for the software from the software activity data. The software operability signature indicates an operability of the software, or generally, the “health” of the software, application, device driver, firmware, hardware, and the like. The software operability module can then communicate the software operability signature and associated contextual data that indicates an operating context to a network service that analyzes the software operability signature.

In other embodiments, the network service can receive a software operability signature and associated contextual data from a computing device. The software operability signature indicates an operability of software operating on the computing device. In an embodiment, the network service can generate a baseline operability signature from additional software operability signatures. The network service can group additional software operability signatures that are received from additional computing devices. Each of the additional software operability signatures indicates an operability of the software operating on the additional computing devices and is associated with contextual data that is the same or similar to the contextual data associated with the software. Then, the network service can generate the baseline operability signature from the additional software operability signatures, and the baseline operability signature indicates normal software operation. The network service can then compare the software operability signature to the baseline operability signature of the software to determine whether the software is operating consistent with the baseline operability signature or inconsistent with the baseline operability signature.

In embodiments, the baseline operability signature that indicates normal software operation may be a function of the context in which the software operability signatures are generated. For example, a baseline operability signature can be generated based on context that may include the architecture of a computing device (e.g., X64 or ARM), performance (e.g., high performance or low performance), market segments under analysis (e.g., based on OEM, PC Model, locale, CPU speed, etc.), and the like. A baseline operability signature that is generated based on only the two variables of a device driver and an operating system build version would have a baseline context of per driver per operating system. Additionally, more dimensions may be added to the baseline context. For example, dimensions of a baseline context may be added to identify the baseline operability signature of a driver for power management functions when running on a tablet computer with under 1 GB memory at a particular locale.

In other embodiments, it may be determined that software is operating inconsistent with the baseline operability signature based on the software operability signature. The network service can then determine that operating inconsistent with the baseline operability signature corresponds to normal software operation. Accordingly, a new baseline operability signature of the software can then be generated based on the software operability signature. Alternatively, the network service can analyze the software operability signature to determine an operation failure or operation regression of the software when it is determined that the software is operating inconsistent with the baseline operability signature based on the software signature. The network service can also determine a cause of the operation failure or regression, and initiate a solution to mitigate the operation failure or regression of the software.

For example, consider a printer and a corresponding printer driver on a computing device. After a service pack update is applied to the computing device, the printer may operate differently, such as by taking a longer time to complete print jobs. Typically, it would be difficult to determine that the printer driver is operating differently, and it would also be difficult to determine that the service pack update caused the speed of the printer to slow down. Over time a user of the printer may notice that the printer seems to be taking longer to complete print jobs, but it may be difficult for the user to pinpoint what caused the decrease in performance. Furthermore, many users may not even notice the decrease in the performance of the printer if the printer driver does not become completely inoperable.

However, in accordance with various embodiments, the software operability module can be implemented to monitor the printer driver to collect printer driver activity data. A software operability signature for the printer driver can then be generated and communicated to the network service. The network service can then compare the software operability signature for the printer driver to a baseline operability signature of the printer driver to determine whether the printer driver is operating consistent or inconsistent with the baseline operability signature. In this case, the network service can determine that the printer driver is operating inconsistent with the baseline operability signature because the printer driver is not operating properly after the service pack update. Responsive to determining that the printer driver is operating inconsistent with the baseline operability signature, the network service can analyze the software operability signature for the printer driver to determine an operation failure or an operation regression of the printer driver. A solution to mitigate the operation failure or the operation regression of the printer driver can then be initiated. For example, the network service can create and/or transmit a software update to the computing device that causes the printer driver to operate properly with the service pack update.

While features and concepts of a software operability service can be implemented in any number of different devices, systems, environments, networks, and/or configurations, embodiments of a software operability service are described in the context of the following example devices, systems, and methods.

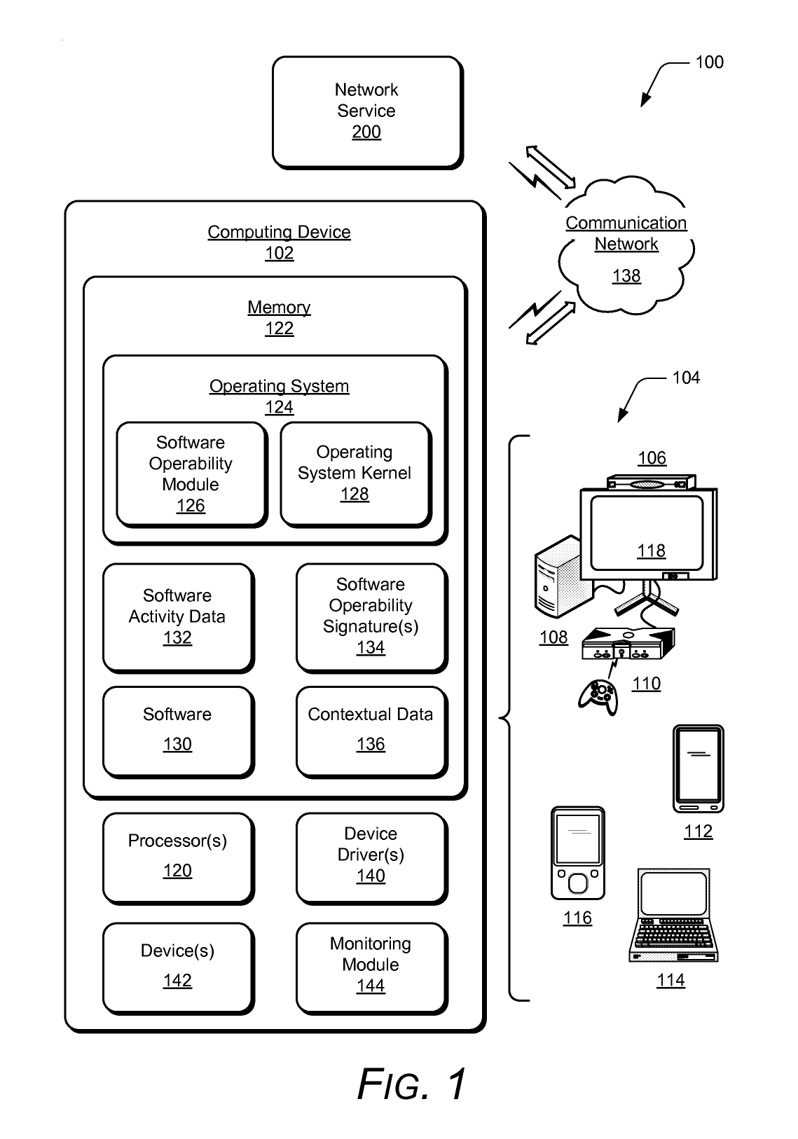

FIG. 1 illustrates an example system 100 in which various embodiments of a software operability service can be implemented. The example system 100 includes a computing device 102, which may be configured as any type of computing device 104. Any of the various computing devices 104 can be configured as the computing device 102, and may be implemented with any number and combination of differing components as further described with reference to the example device shown in FIG. 6.

A computing device 104 can be implemented as any one or combination of a television device 106, a computer 108, a gaming system 110, an appliance device, an electronic device, and/or as any other type of device. The various computing devices can also include wireless devices implemented to receive and/or communicate wireless data, such as any one or combination of a mobile phone 112 (e.g., cellular, VoIP, WiFi, etc.), a portable computer device 114, a media player 116, and/or any other wireless device. A client system can include a respective computing device and display device 118.

The computing device 102 can include one or more processors 120 (e.g., any of microprocessors, controllers, and the like) which process various computer-executable instructions to control the operation of the computing device. The computing device 102 also includes memory 122 (e.g., one or more computer-readable storage media devices) that enable data storage. The memory can be implemented as any type of memory, storage media, and/or suitable electronic data storage.

The memory 122 also includes an operating system 124 that can be maintained as a software application with the memory and executed by processor 120. The operating system includes a software operability module 126 and an operating system kernel 128. The software operability module 126 can be implemented as computer-executable instructions, such as a software application, and executed by processors on any of the various computing devices 104 to implement the embodiments described herein.

The software operability module 126 is implemented to monitor activities of software 130 to collect software activity data 132. As described herein, software can include any type of software application, such as a word processing application, a web browser application, or a device driver, to name a few. The software can also include firmware (e.g., device firmware or system firmware), microcode, hardware components, or any combination thereof. The software activity data can include any data related to the activity and/or behavior of the software, including normal software activities, software behavior changes, and software failures.

In an embodiment, the software operability module 126 is implemented to receive a request from a network service 200 (described in more detail below) to monitor specific activities of the software. For example, a request can be received to monitor specific activities related to power management behavior of software, and to ignore all other activities. Alternatively, the software operability module can be implemented to monitor all activities of the software.

In an embodiment, the software operability module 126 is implemented to select software for monitoring based on one or more criteria. The one or more criteria can be generated by the software operability module itself or the criteria can be received from the network service 200. For example, the software operability module can be implemented to select software for monitoring randomly or by discovering some noticeable behavior, such as a sequence of error events. As another example, the network service may use sampling logic to ensure that a broad assortment of software is monitored in order to compile a broad picture of the operability of various computing devices.

The software operability module 126 is implemented to then generate a software operability signature 134 for the software from the software activity data 132. The software operability signature indicates an operability of the software and may include a summary of the software activity data. For example, the software operability signature can include indicators that the software crashed, did not finish an application task, or failed to perform an application operation. It is to be appreciated, therefore, that the software operability signature provides a snapshot of the operability of the software during the time that the software is monitored.

In an embodiment, the software operability module 126 is implemented to collect the software activity data 132 and generate the software operability signature 134 responsive to a triggering event. The triggering event ensures that the software activity data used to generate the software operability signature is consistent. The triggering event can be a specific event, such as a computing device restart, or a specific time or period of time. For example, the software operability signature can be generated each time that the computing device restarts, every day at 8:00 a.m., or every twelve hours. The triggering event may be determined by the software operability module, or the triggering event may be selected based on commands received from the network service.

The software operability module 126 is implemented to then communicate the software operability signature 134 and associated contextual data 136 to the network service 200 that analyzes the software operability signature. In an embodiment, the contextual data may be gathered and/or communicated by another system or entity, in which case the software operability signature may be communicated along with a pointer or reference to the contextual data.

The contextual data 136 identifies an operating environment in which the software activity data is collected and in which the software operability signature is generated. The contextual data may include any information associated with the configuration or operating environment of the computing device that may have an impact on the operation of the software. For example, the contextual data may include hardware, firmware, or bios type information, the types of devices associated with the computing device (e.g., embedded, internal, and external devices), the types of drivers of the computing device, and/or the type of the operating system. The contextual data may also include time data corresponding to a time at which the software activity data was collected or environmental data corresponding to an environment of the computing device (such as the status of the operating system) at the time that the software activity data was collected.

It is to be appreciated that the operation of the software may be greatly influenced by the context or operating environment of the software. Therefore, the quality and the amount of the contextual data collected may impact the analysis of the software operability signature by the network service. For example, the software or a device may operate differently on a 32 bit system as opposed to on an ARM system. Similarly, a device may operate differently when there are two or more of the same devices operating on the same computing device. Accordingly, context may influence the software operability signature. Therefore, the more contextual data that can be associated with each signature is better, as this will aid in the backend analysis of the signature by the network service.

The software operability module 126 can communicate with the network service 200 via a communication network 138, which can be implemented to include a wired and/or a wireless network that facilitates communication and distribution of software operability signatures 134. The communication network can also be implemented using any type of network topology and/or communication protocol, and can be represented or otherwise implemented as a combination of two or more networks. The communication network may also include mobile operator networks that are managed by mobile operators, such as a communication service provider, cell-phone provider, and/or Internet service provider. A mobile operator can facilitate mobile data and/or voice communication for any type of a wireless device or mobile phone (e.g., cellular, VoIP, Wi-Fi, etc.).

In various embodiments, software 130 comprises a device driver 140 that is implemented to control a corresponding device 142 via communication with the operating system kernel 128. Examples of devices 142 include a keyboard, a speaker, a printer, a universal serial bus (USB) storage device, a webcam, and any other type of hardware device that can interface with computing device 102. In an embodiment, the software operability module 126 is implemented to monitor the device driver 140 using a monitoring module 144 that passively monitors communications between the device driver and the operating system kernel to collect the software activity data. The monitoring module may be configured as a “shim” that passively monitors the communications between the device driver and the operating system kernel to collect software activity data corresponding to the device driver. As described herein, “passively” monitoring refers to monitoring without interfering with the communications between the device driver and the operating system kernel.

The software operability module 126 is implemented to then generate a software operability signature 134 from the software activity data corresponding to the device driver. For example, the software operability signature can include indicators that the device driver crashed, did not finish, or failed. A device driver operation failure, for example, can include instances in which a device driver failed to properly respond to a command from the operating system kernel, such as by failing to enter a requested power state which results in a less than optimal battery life for the computing device. The software operability signature provides a snapshot of the operability of the device driver during the time that the device driver is monitored. The software operability module 126 then communicates the software operability signature corresponding to the device driver to the network service 200 that analyzes the software operability signature, as described above.

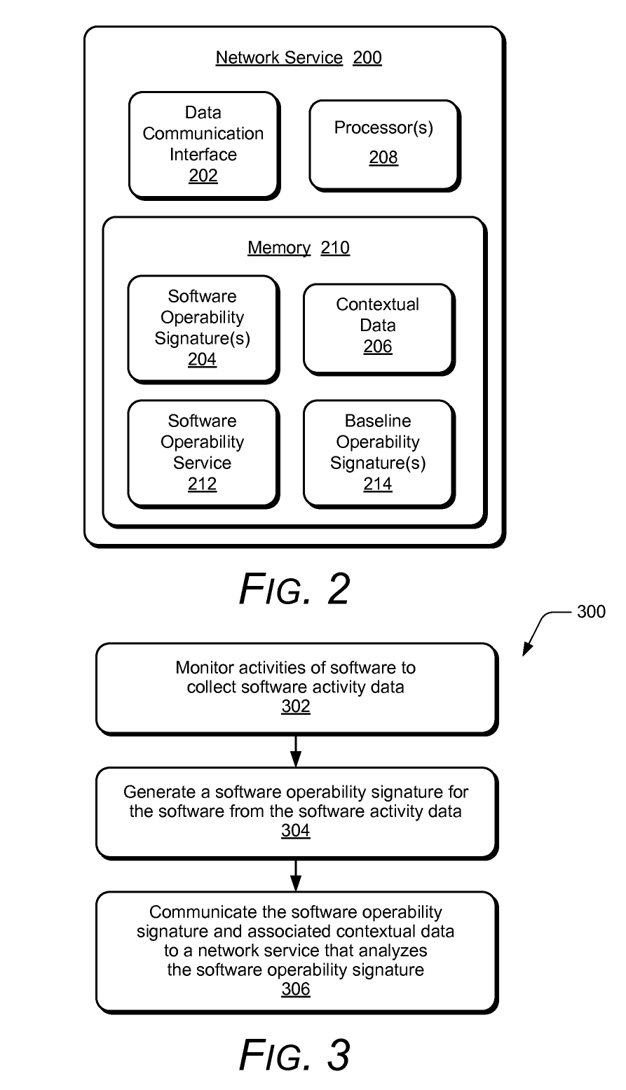

FIG. 2 illustrates an example network service 200 in accordance with embodiments described herein. The network service includes a data communication interface 202 via which software operability signatures 204 and associated contextual data 206 are received from a computing device 102 as described with reference to FIG. 1.

The network service 200 can also include one or more processors 208 (e.g., any of microprocessors, controllers, and the like) which process various computer-executable instructions to control the operation of the network service. The network service also includes memory 210 (e.g., one or more computer-readable storage media devices) that enable data storage. The memory can be implemented as any type of memory, storage media, and/or suitable electronic data storage. The network service can also be implemented with any number and combination of differing components as further described with reference to the example device shown in FIG. 6. The network service 200 also includes a software operability service 212 that can be implemented as computer-executable instructions, such as a software application, and executed by one or more processors 208 to implement the various embodiments described herein.

The software operability service 212 is implemented to receive a software operability signature 204 and associated contextual data 206 from a computing device 102. As described with reference to FIG. 1, the software operability signature indicates an operability of software 130 operating on the computing device.

In an embodiment, the software operability service 212 is implemented to determine a baseline operability signature 214 that indicates normal software operation. To generate the baseline operability signature, the software operability service can group additional software operability signatures 204 received from additional computing devices 102. Each of the additional software operability signatures indicates an operability of the software 130 operating on the additional computing devices. The software operability service 212 can then generate the baseline operability signature from the additional software operability signatures, and the baseline operability signature indicates normal software operation. The baseline operability signature may be a function of the context in which the additional software operability signatures are generated. For example, a baseline operability signature can be generated based on context that may include the architecture of a computing device, performance of the device, and/or features of the device that are selected for analysis.

In embodiments, the baseline operability signature 214 indicates normal software operation when the software is operating in the same or similar operating environment and/or when the same or similar software activities are monitored. For instance, the baseline operability signature 214 may be dynamically generated by grouping additional software operability signatures that are associated with contextual data that is the same or similar to the contextual data associated with the software operability signature. This provides that the context or operating environment of the computing device does not affect the comparison of the software operability signature to the baseline signature.

For example, a display driver that requires a minimum BIOS version may operate poorly on a computing device with an older BIOS version, but operate properly on systems with a new BIOS version. Therefore, if the software operability signature is generated from a computing device with the new BIOS, and the baseline operability signature is generated from additional software operability signatures on computing device with an older BIOS version, the comparison will not be accurate. Accordingly, when comparing a software operability signature to a baseline operability signature for the display driver, both the software operability signature and the baseline signature are generated from computing devices with the new BIOS version.

Alternatively or in addition to being associated with the same or similar contextual data, the software operability signature and the additional software operability signatures may be generated from monitoring the same or similar activities of the software. For example, if the software operability signature is generated by monitoring activities related to power management behavior, then the additional software operability signatures used to generate the baseline operability signature can be grouped based on also being generated by monitoring activities related to power management behavior. Accordingly, the additional software operability signatures used to generate the baseline operability signature can be grouped based on one or more having the same or similar contextual data, or being generated from monitoring the same or similar software activities in order to generate an accurate baseline operability signature.

The software operability service 212 is implemented to compare the software operability signature 204 to the baseline operability signature 214 of the software to determine whether the software is operating consistent with the baseline operability signature or inconsistent with the baseline operability signature. The baseline operability signature indicates normal software operation. Accordingly, by comparing the software operability signature to the baseline operability signature, the network service can determine whether the software is operating consistent or inconsistent with normal software operation or behavior.

For example, the software operability service can graph the software operability signatures along with the baseline operability signature in a data chart and statistically analyze the signatures to determine whether the software is operating consistent or inconsistent with the baseline operability signature. For example, if the software operability signature maps to the baseline operability signature, then the software operability service determines that the software is operating consistent with the baseline operability signature. Alternately, if the software operability signature does not map to the baseline operability signature, then the software operability service can determine that the software is operating inconsistent with the baseline operability signature.

In an embodiment, the software operability service 212 can determine that software 130 is operating inconsistent with the baseline operability signature 214 based on the software operability signature 204, and then determine that the software operating inconsistent with the baseline operability signature corresponds to normal software operation. For example, a computing device update may cause the software to operate differently, which may cause the software operability signature to change. However, in some cases the different operation of the software may correspond to an acceptable or better operation of the software. In these instances, therefore, the different software operability signature may now correspond to normal software operation. Accordingly, the software operability service 212 is implemented to then generate a new baseline operability signature of the software based on the software operability signature received for the software.

In another embodiment, the software operability service 212 can determine that the software 130 is operating inconsistent with the baseline operability signature 214 based on the software operability signature 204, and then analyze the software operability signature to determine an operation failure of the software. An operation failure of the software can correspond to a failure of the software to operate properly. To determine an operation failure of the software, the software operability service analyzes the software operability signature 204 corresponding to the inconsistent operation to determine whether the software operability signature indicates a failure of the software. For example, the software operability signature may indicate that the software crashed or did not finish execution of a particular command. As another example, the software operability signature may indicate that a device driver failed to change power states when requested to change power states by the operating system kernel.

In another embodiment, the software operability service 212 can determine that the software 130 is operating inconsistent with the baseline operability signature 214 based on the software operability signature 204, and then analyze the software operability signature to determine an operation regression of the software. An operation regression of the software refers to instances in which the operability of the software regresses (e.g., the performance of the software decreases) in response to a computing device update, such as an operating system update or a service pack update.

Operation regressions can be identified by comparing a software operability signature 204 of the software 130 received after a computing device update to a baseline operability signature 214 generated before the computing device update. For example, a software operability signature received after a service pack update should be the same, or approximately the same, as a baseline operability signature generated before the service pack update. However, if a software operability signature is different than the baseline operability signature after the service pack update, then the software operability signature can be examined to see if the software operability signature corresponds to a decrease in the performance of the software indicative of an operation regression.

For example, by analyzing the software operability signatures for a printer driver, the software operability service 212 may determine that a printer driver fails 5% of the time during a particular step of a printing process, when running an older version of an operating system. However, the software operability signatures may indicate that when a newer version of the operating system is installed, the printer device driver now fails 20% of the time when performing the particular step of the printing process. The fact that the printer driver fails more often with the newer version of the operating system indicates that the performance of the printer driver has decreased or regressed in response to the operating system upgrade.

The software operability service 212 is implemented to then determine a cause of the operation failure or operation regression of the software 130 from the comparison of the software operability signature 204 to the baseline operability signature 214. For example, the software operability service can examine the contextual data 206 associated with the software to determine the cause of the operation failure or the operation regression of the software.

The software operability service 212 is implemented to then initiate a solution to mitigate the operation failure or the operation regression of the software 130. For example, the software operability service and/or another service or process can initiate a software solution to mitigate the operation failure or operation regression. For example, a software solution may be initiated that updates a printer driver for compatibility with a newer version of the operating system.

The solution can then be communicated over the communication network 138 to a computing device 102 to mitigate the operation failure or operation regression of the software at the computing device. Alternatively or in addition, information about the operation failure or operation regression can be communicated to the manufacturer or developer of the software (or to another third party) so that the third party can develop a solution to mitigate the operation failure or operation regression of the software. The software operability service can also tag the software operability signature corresponding to the operation failure or operation regression to initiate automatic updating of computing devices with the solution when the operation failure or operation regression is subsequently detected.

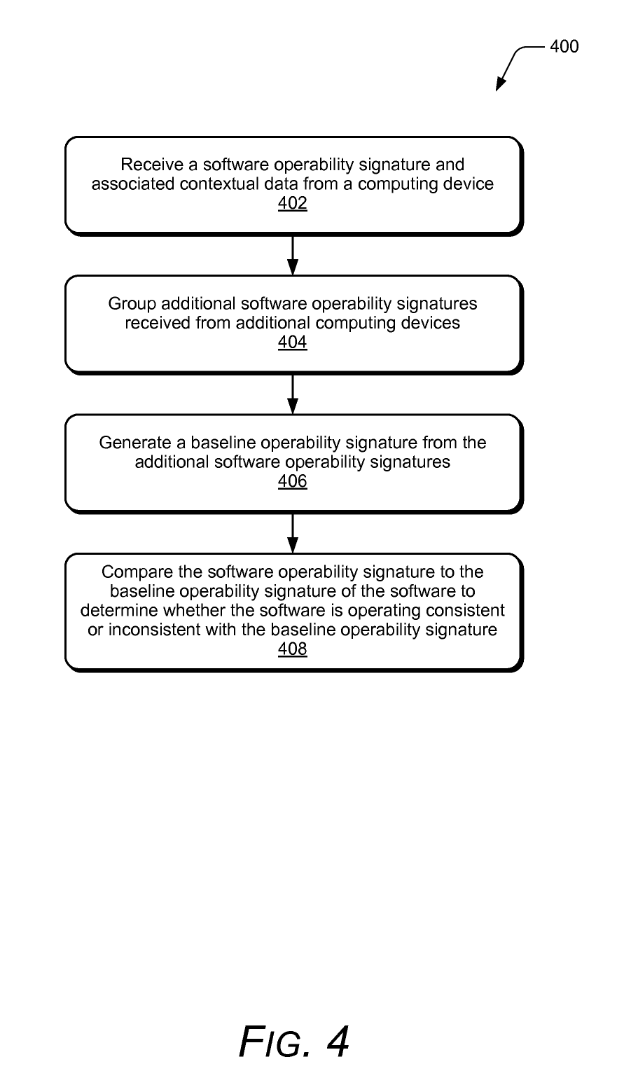

Example methods 300, 400, and 500 are described with reference to respective FIGS. 3, 4, and 5 in accordance with one or more embodiments of a software operability service. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 3 illustrates example method(s) 300 of a software operability service, and is described with reference to a software operability module implemented in a computing device. The order in which the method blocks are described are not intended to be construed as a limitation, and any number of the described method blocks can be combined in any order to implement a method, or an alternate method.

At block 302, software is monitored to collect software activity data. For example, the software operability module 126 at computing device 102 (FIG. 1) monitors software 130 to collect software activity data 132. At block 304, a software operability signature for the software is generated from the software activity data. For example, the software operability module 126 generates a software operability signature 134 for software 130 from the software activity data 132.

At block 306, the software operability signature and associated contextual data is communicated to a network service that analyzes the software operability signature. For example, the software operability module 126 communicates the software operability signature 134 and associated contextual data 136 to the network service 200 (FIG. 2) that analyzes the software operability signature.

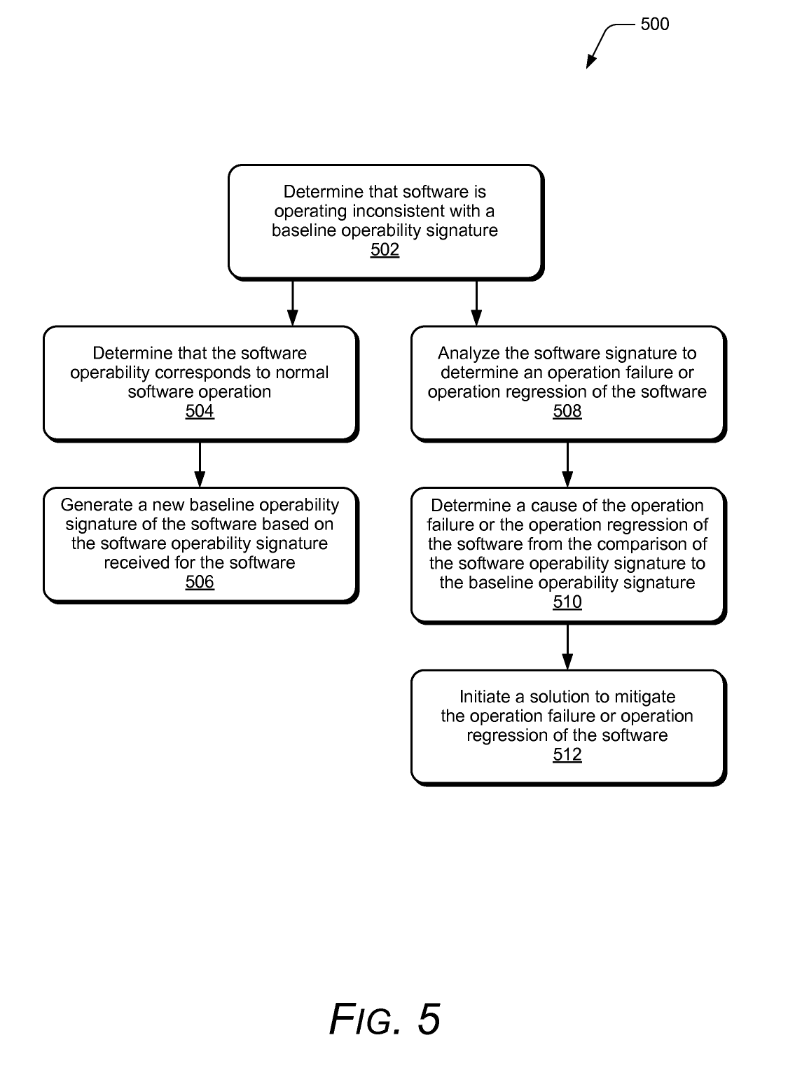

FIG. 4 illustrates example method(s) 400 of a software operability service, and is described with reference to the network service shown in FIG. 2. The order in which the method blocks are described are not intended to be construed as a limitation, and any number of the described method blocks can be combined in any order to implement a method, or an alternate method.

At block 402, a software operability signature and associated contextual data is received from a computing device. For example, the network service (200) (FIG. 2) receives a software operability signature 204 and associated contextual data 206 from a computing device 102 (FIG. 1). The software operability signature indicates an operability of the software 130 operating on the computing device.

At block 404, additional software operability signatures received from additional computing devices are grouped. For example, the software operability service 212 groups additional software operability signatures 204 received from additional computing devices 104. Each of the additional software operability signatures indicates an operability of the software operating on the additional computing devices. In addition, each of the additional software operability signatures may be associated with contextual data that is the same or similar to the contextual data associated with the software operability signature.

At block 406, a baseline operability signature is generated from the additional software operability signatures. For example, the software operability service 212 generates a baseline operability signature 214 from the additional software operability signatures. In embodiments, the baseline operability signature may be a function of the context in which the additional software operability signatures are generated. For example, a baseline operability signature can be generated based on context that may include the architecture of a computing device, performance of the device, and/or features of the device that are selected for analysis.

At block 408, the software operability signature is compared to the baseline operability signature of the software to determine whether the software is operating consistent or inconsistent with the baseline operability signature. For example, the software operability service 212 compares the software operability signature 204 to the baseline operability signature 214 of the software to determine whether the software is operating consistent with the baseline operability signature or inconsistent with the baseline operability signature.

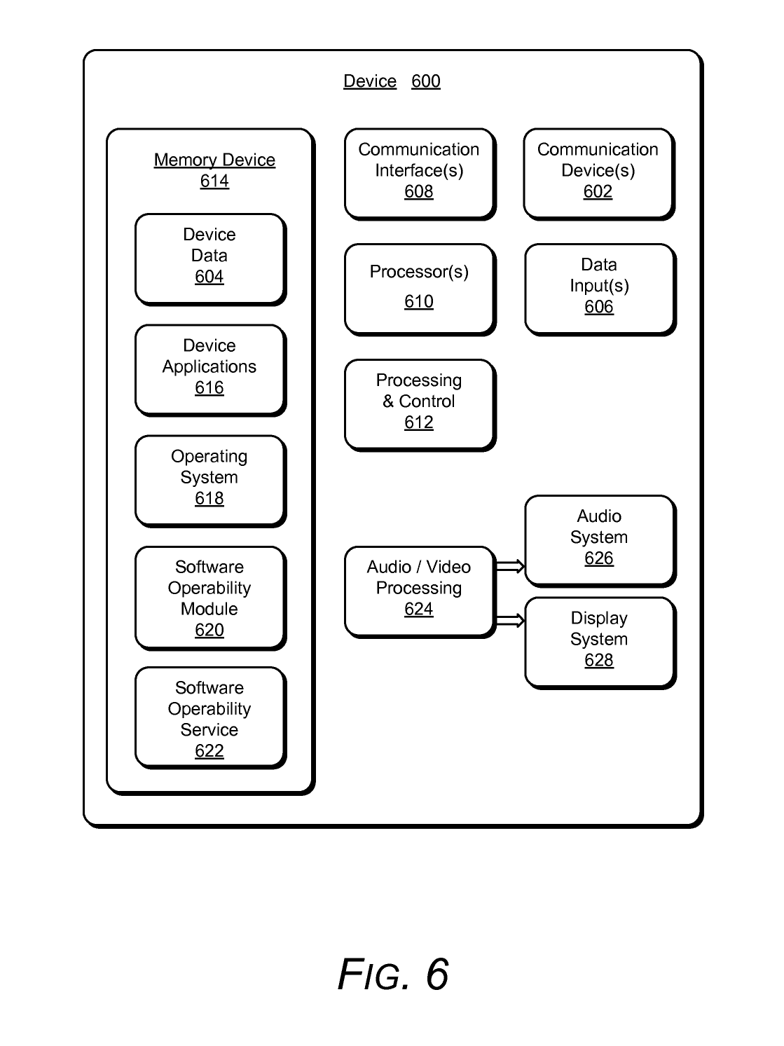

FIG. 5 illustrates example method(s) 500 of a network service, and is described with reference to the software operability service shown in FIG. 2. The order in which the method blocks are described are not intended to be construed as a limitation, and any number of the described method blocks can be combined in any order to implement a method, or an alternate method.

At block 502, it is determined that software is operating inconsistent with a baseline operability signature based on the software operability signature. For example, the software operability service 212 (FIG. 2) determines that the software 130 is operating inconsistent with the baseline operability signature 214 based on the software operability signature 204 (e.g., as may be determined based on the comparison described with reference to block 408 (FIG. 4)). Responsive to determining that the software is operating inconsistent with the baseline operability signature, the method can optionally continue at block 504 or block 508.

In an embodiment, at block 504, it is determined that the software operating inconsistent with the baseline operability signature corresponds to normal software operation. For example, the software operability service 212 determines that the software 130 operability corresponds to normal software operation, even though the software operability is inconsistent with the baseline operability signature.

At block 506, a new baseline operability signature is generated based on the software operability signature received for the software. For example, the software operability service 212 generates a new baseline operability signature 214 based on the software operability signature 204 received for the software 130. In another embodiment, at block 508, the software operability signature is analyzed to determine an operation failure or an operation regression of the software. For example, the software operability service 212 analyzes the software operability signature 204 to determine an operation failure or an operation regression of the software 130.

At block 510, a cause of the operation failure or the operation regression of the software is determined from the comparison of the software operability signature to the baseline operability signature. For example, the software operability service 212 determines a cause of the operation failure or the operation regression of the software 130 from the comparison of the software operability signature 204 to the baseline operability signature 214. Additionally, the context of the baseline operability signature may be a factor that is considered when determining the operation failure or operation regression of the software. At block 512, a solution to mitigate the operation failure or the operation regression of the software is initiated. For example, the software operability service 212 initiates a solution to mitigate the operation failure or the operation regression of the software 130.

FIG. 6 illustrates various components of an example device 600 that can be implemented as any of the devices, or services implemented by devices, described with reference to the previous FIGS. 1-5. In embodiments, the device may be implemented as any one or combination of a fixed or mobile device, in any form of a consumer, computer, server, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 600 includes communication devices 602 that enable wired and/or wireless communication of device data 604, such as received data, data that is being received, data scheduled for broadcast, data packets of the data, etc. The device data or other device content can include configuration settings of the device, media content stored on the device, and/or information associated with a user of the device. Media content stored on the device can include any type of audio, video, and/or image data. The device includes one or more data inputs 606 via which any type of data, media content, and/or inputs can be received, such as user-selectable inputs, messages, communications, music, television content, recorded video content, and any other type of audio, video, and/or image data received from any content and/or data source.

The device 600 also includes communication interfaces 608, such as any one or more of a serial, parallel, network, or wireless interface. The communication interfaces provide a connection and/or communication links between the device and a communication network by which other electronic, computing, and communication devices communicate data with the device.

The device 600 includes one or more processors 610 (e.g., any of microprocessors, controllers, and the like) which process various computer-executable instructions to control the operation of the device. Alternatively or in addition, the device can be implemented with any one or combination of software, hardware, firmware, or fixed logic circuitry that is implemented in connection with processing and control circuits which are generally identified at 612. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 600 also includes one or more memory devices (e.g., computer-readable storage media) 614 that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like. The device may also include a mass storage media device.

Computer readable media can be any available medium or media that is accessed by a computing device. By way of example, and not limitation, computer readable media may comprise storage media and communication media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. The term modulated data signal means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 614 provides data storage mechanisms to store the device data 604, other types of information and/or data, and various device applications 616. For example, an operating system 618 can be maintained as a software application with a memory device and executed on the processors. The device applications may also include a device manager, such as any form of a control application, software application, signal processing and control module, code that is native to a particular device, a hardware abstraction layer for a particular device, and so on.

In this example, the device applications 616 include a software operability module 620, such as when device 600 is implemented as a computing device. Alternatively or in addition, the device applications include a software operability service 622, such as when the device is implemented as the network service described with reference to FIG. 2. The software operability module and the software operability service are shown as software and/or computer applications. Alternatively or in addition, the software operability module and/or the software operability service can be implemented as hardware, software, firmware, fixed logic, or any combination thereof.

The device 600 also includes an audio and/or video processing system 624 that generates audio data for an audio system 626 and/or generates display data for a display system 628. The audio system and/or the display system may include any devices that process, display, and/or otherwise render audio, video, display, and/or image data. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device.

Although embodiments of a software operability service have been described in language specific to features and/or methods, the subject of the appended claims is not necessarily limited to the specific features or methods described. Rather, the specific features and methods are disclosed as example implementations of a software operability service.

1. A computer-implemented method, comprising:
receiving a software operability signature and associated contextual data from a computing device, the software operability signature indicating an operability of software operating on the computing device; and
comparing the software operability signature to a baseline operability signature of the software to determine whether the software is operating consistent with the baseline operability signature or inconsistent with the baseline operability signature.

2. A computer-implemented method as recited in claim 1, further comprising:
grouping additional software operability signatures received from additional computing devices, each of the additional software operability signatures indicating an operability of the software operating on the additional computing devices and being associated with contextual data that is the same or similar to the contextual data associated with the software operability signature; and
generating the baseline operability signature from the additional software operability signatures, the baseline operability signature indicating normal software operation.

3. A computer-implemented method as recited in claim 2, wherein the software operability signature and the additional software operability signatures are generated from monitoring the same or similar activities of the software.

4. A computer-implemented method as recited in claim 1, further comprising:
determining that the software is operating inconsistent with the baseline operability signature based on the software operability signature;
determining that the software operating inconsistent with the baseline operability signature corresponds to normal software operation; and
generating a new baseline operability signature of the software based on the software operability signature received for the software.

5. A computer-implemented method as recited in claim 1, further comprising:
determining that the software is operating inconsistent with a context of the baseline operability signature based on the software operability signature; and
analyzing the software operability signature to determine an operation failure of the software.

6. A computer-implemented method as recited in claim 5, further comprising:
determining a cause of the operation failure of the software from the comparison of the software operability signature to the context of the baseline operability signature; and
initiating a solution to mitigate the operation failure of the software.

7. A computer-implemented method as recited in claim 1, further comprising:
determining that the software is operating inconsistent with a context of the baseline operability signature based on the software operability signature; and
analyzing the software operability signature to determine an operation regression of the software.

8. A computer-implemented method as recited in claim 7, further comprising:
determining a cause of the operation regression of the software from the comparison of the software operability signature to the context of the baseline operability signature; and
initiating a solution to mitigate the operation regression of the software.

9. A computer-implemented method, comprising:
monitoring activities of software to collect software activity data;
generating a software operability signature for the software from the software activity data, the software operability signature indicating an operability of the software; and
communicating the software operability signature and associated contextual data to a network service that analyzes the software operability signature.

10. A computer-implemented method as recited in claim 9, wherein the software comprises at least one of a device driver, an application, firmware, or microcode, and wherein monitoring the software includes passively monitoring communications between the software and an operating system kernel to collect the software activity data.

11. A computer-implemented method as recited in claim 9, wherein the contextual data identifies an operating environment in which the software activity data is collected.

12. A computer-implemented method as recited in claim 9, wherein the software activity data is collected and the software operability signature is generated responsive to a triggering event.

13. A computer-implemented method as recited in claim 9, wherein the software is one of selected for monitoring based on one or more criteria, or selected for monitoring in response to receiving a request to monitor the software from the network service.

14. A computer-implemented method as recited in claim 9, further comprising receiving a request from the network service to monitor specific activities of the software.

15. A network service, comprising:
a data communication interface configured to receive a software operability signature and associated contextual data from a computing device, the software operability signature indicating an operability of an software operating on the computing device; and
at least a memory and a processor to implement a software operability service configured to compare the software operability signature to a baseline operability signature of the software to determine whether the software is operating consistent with the baseline operability signature or inconsistent with the baseline operability signature.

16. A network service as recited in claim 15, wherein the software operability service is further configured to:
group additional software operability signatures received from additional computing devices, each of the additional software operability signatures indicating an operability of the software operating on the additional computing devices and being associated with contextual data that is the same or similar to the contextual data associated with the software operability signature; and
generate the baseline operability signature from the additional software operability signatures, the baseline operability signature indicating normal software operation.

17. A network service as recited in claim 16, wherein the software operability signature and the additional software operability signatures are generated from monitoring the same or similar activities of the software.

18. A network service as recited in claim 15, wherein the software operability service is further configured to:
determine that the software is operating inconsistent with the baseline operability signature based on the software operability signature;
determine that the software operating inconsistent with the baseline operability signature corresponds to normal software operation; and
generate a new baseline operability signature of the software based on the software operability signature received for the software.

19. A network service as recited in claim 15, wherein the software operability service is further configured to:
determine that the software is operating inconsistent with the baseline operability signature based on the software operability signature; and
analyze the software operability signature to determine an operation failure or an operation regression of the software.

20. A network service as recited in claim 19, wherein the software operability service is further configured to:
determine a cause of the operation failure or the operation regression of the software from the comparison of the software operability signature to the baseline operability signature; and
initiate a solution to mitigate the operation failure or the operation regression of the software.
